(19) United States
(12) Patent Application Publication
(10) Pub. No.: US 2006/0245626 A1
(43) Pub. Date: Nov. 2, 2006

(54) Fingerprint identifying entrance guard device

(75) Inventor: Cheng-I Yang, Taichung City (TW)

Correspondence Address: BRUCE H. TROXELL, SUITE 1404, 5205 LEESBURG PIKE, FALLS CHURCH, VA, 22041, US

(73) Assignee: Jeyeefox Innovative Design International Ltd.

(21) Appl. No.: 11/410,190

(22) Filed: Apr. 25, 2006

(30) Foreign Application Priority Data
Apr. 29, 2005 (TW) 94206928

(51) Int. Cl. G06K 9/00

(52) U.S. Cl. 382/125

(57) ABSTRACT

The present invention is a fingerprint identifying entrance guard device which comprising a base set up on the door board of a house, a fingerprint identifier is set up on the base and connected with the lock of the door board so as to set and identify the fingerprint of visitors, after visitors have passed the fingerprint identifying, the lock can then be opened, a monitor is set up on the base so as to monitor the appearance of the visitors outside the house.

### BACKGROUND OF THE INVENTION

1. Field of the Invention

The present invention is a fingerprint identifying entrance guard device which contains a base set up on the door board of a house; a fingerprint identifier is set up on the base and connected with the lock of the door board so as to set and identify the fingerprint of visitors. After visitors have passed the fingerprint identifying, the lock can then be opened; a monitor is set up on the base so as to monitor the appearance of the visitors outside the house.

2. Description of the Prior Art

The present invention relates to a door lock, in more details, a fingerprint identifying entrance guard device.

Accordingly, the kinds of the locks on the door board which common houses widely use are key locks, number locks and fingerprint locks, etc. Because fingerprint locks apply the design of a fingerprint identifier to identify the fingerprint of the visitors through the switch of the front door (i.e. a handle switch) or lock (i.e. an anode lock) connected the fingerprint of the visitors so as to open the switch or lock. Therefore, its safety is better than the other kinds of locks.

Nevertheless, in regard to safety, the effects of simply replying on locks to prevent outlaws from breaking into the house when the occupants are absent are still inadequate.

Therefore, more and more homes, organizations, or corporations have installed monitoring video cameras outside the buildings so as to promote the effects of entrance guard by double safeguard by both locks and video cameras.

However, if installed angles of the monitor video camera are not good, the effects of fully monitoring the whole appearance and movement of the visitor outside the house can not be achieved. Obviously, this way still has a variable which influence the effects of the entrance guard.

To solve the afore-mentioned defects, the main objective of the present invention is to provide a Fingerprint Identifying Entrance Guard Device, which has both effects of fingerprint identifying and effectively monitoring the whole appearance and movement of the visitor outside the house and even has practical value.

### SUMMARY OF THE INVENTION

Therefore, in order to achieve the afore-mentioned objective, the present invention is to provide a Fingerprint Identifying Entrance Guard Device, which contains a base set up on the door board of a house; a fingerprint identifier is set up on the base and connected with the lock of the door board so as to set and identify the fingerprint of the visitors. After the visitors have passed the fingerprint identifying, the lock can then be opened; a monitor is set up on the base so as to monitor the appearance of the visitors outside the house.

### BRIEF DESCRIPTION OF THE DRAWINGS

Hereunder stated in preferred embodiments in accommodation with a detailed description of the present invention as follows:

FIG. 1 is the front schematic view of a preferred embodiment of the present invention.

FIG. 2 is the rear schematic view of a preferred embodiment of the present invention.

FIG. 3 is the plane schematic view of a preferred embodiment's pedestal lifted from the backside of the panel of.

FIG. 4 is the schematic view of a preferred embodiment set up on the door board.

FIG. 5 is the front schematic view of another preferred embodiment of the present invention.

### DETAILED DESCRIPTION OF THE INVENTION

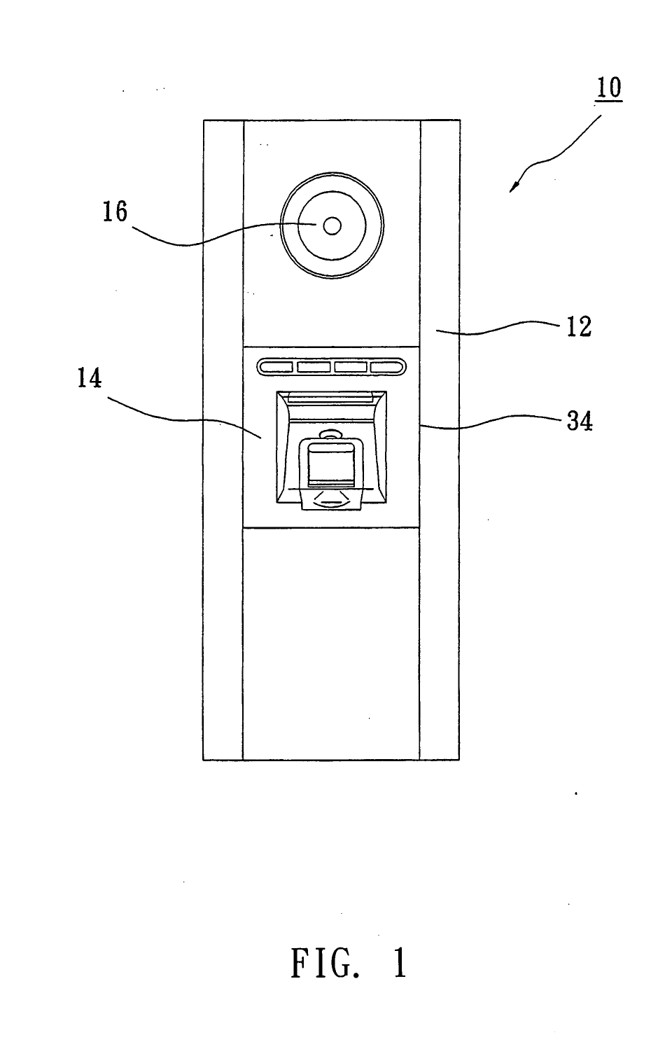

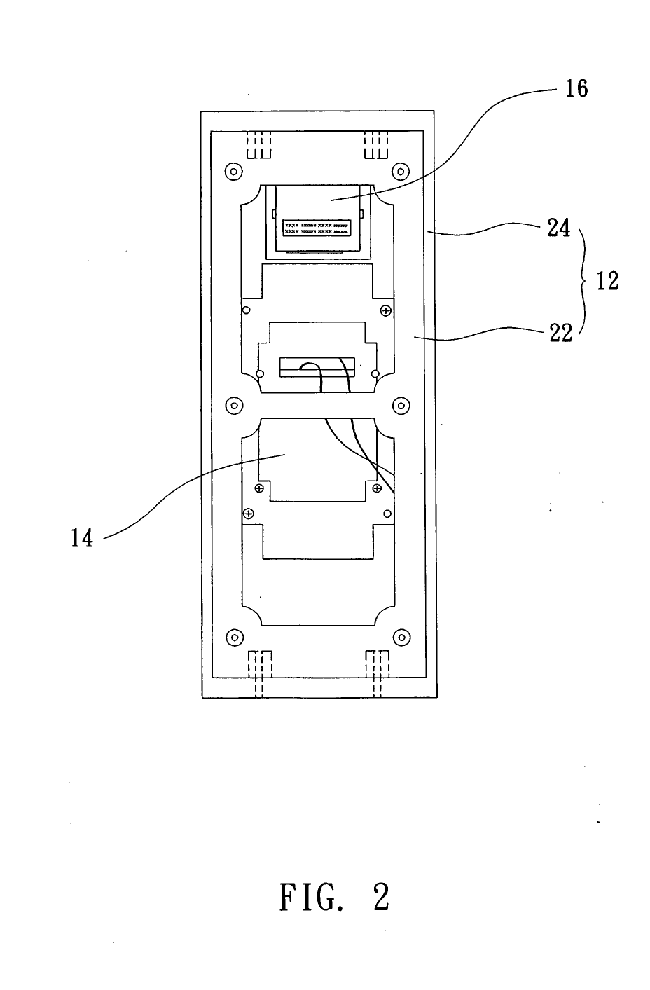

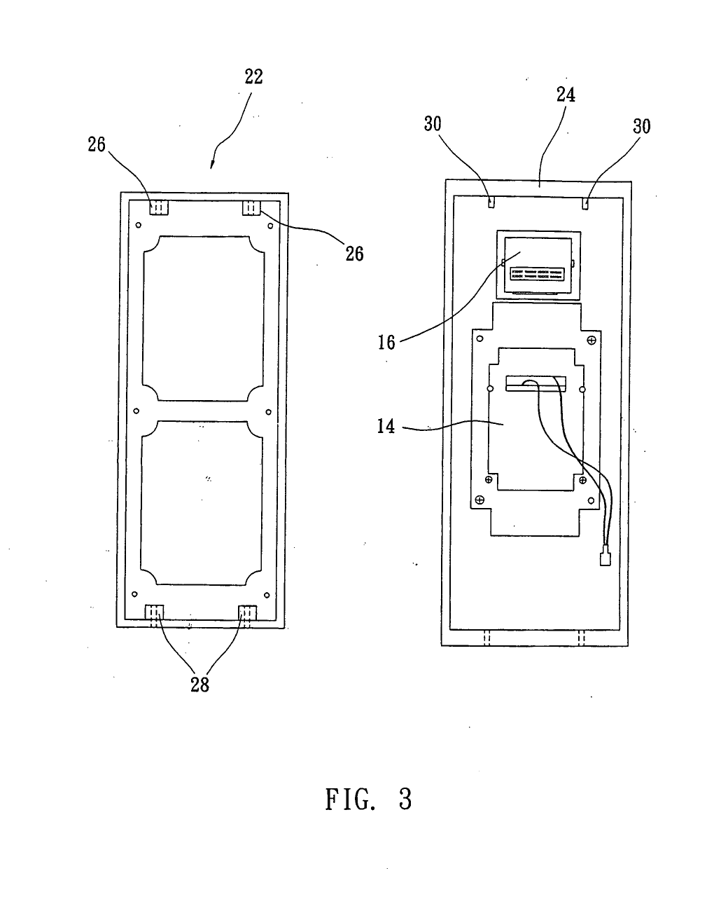

First, please refer to the things shown on FIG. 1 to FIG. 3, fingerprint identifying entrance guard device 10 of the preferred embodiment of the present invention consists of a base 12, a fingerprint identifier 14 and a monitor 16.

The base 12 is set up by covering relatively with a pedestal 22 and a panel 24, which in the inner side of the end of pedestal 22 there is set up with two sockets 26, and in the inner side of another end is set up with two locking connecting stands 28, which in the inner side of the end of the panel 24 is set up with two bolts 30 correspondingly insert into the socket 26, and in the inner side of another end is set up with two lock holes 32 by screw (not shown in the drawing) and locked and connected with socket 26; meanwhile, there is further set up with two containing opening 34, 36 on the panel 24.

The fingerprint identifier 14 is fixed on the position in the inner side of the panel 24 corresponding to the containing opening 34 and connected with the anode lock on the door board (not shown in the drawing and can also be connected with handle switch) is the aforementioned fingerprint identifier, which can be provided for the users to set up password and input fingerprint so as to recognize if the fingerprint of the person who wants to open the door matches the information input in advance. If both the password and the fingerprint input by the person who wants to open the door match the information input in advance, the anode lock can then be opened (or use the handle switch can be turned on) to open the door board.

The monitor 16 is fixed on the position in the inner side of the panel 24 corresponding to the containing opening 36 and connected with the computer or VCR equipments inside the house, which is a conventional Charge Coupled Device (CCD) video camera used to shot the appearance of the visitors and to be recorded the vision by a computer or VCR equipments.

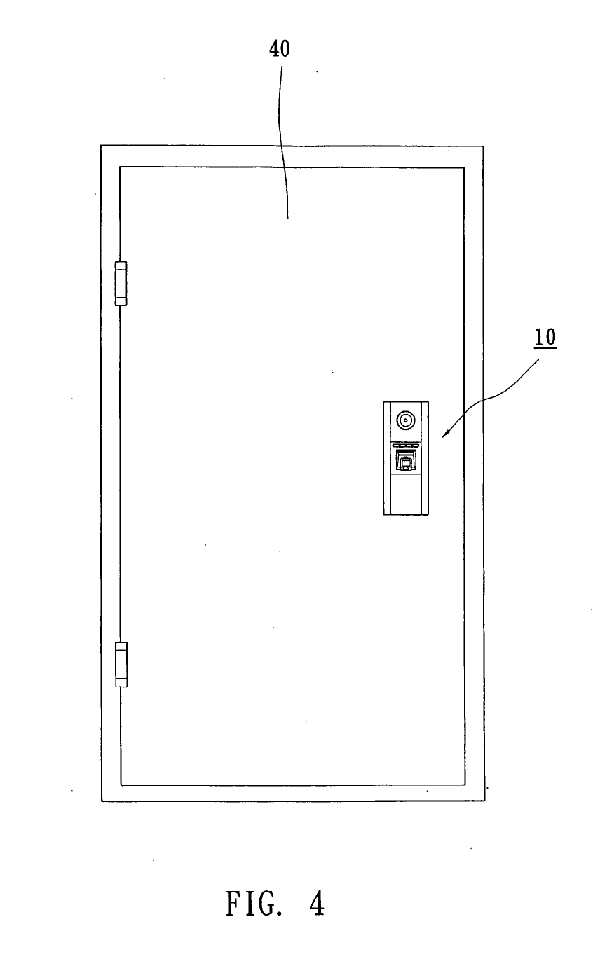

Thus, as shown in FIG. 4, the present invention is an integrated design of fingerprint identifying entrance guard device 10 set up on the door board 40 with a fingerprint identifier 14 and a monitor 16. When the visitor who wants to enter and operate the fingerprint identifier 14, the monitor 16 can then shot the appearance of the visitor and record the vision and the effects of entrance guard can be better in accommodation with the way of operation of fingerprint identifier 14 and meanwhile to avoid the conventional defects which cannot fully monitor the whole appearance and movement of the visitor because of the bad installed angles of the monitoring video camera.

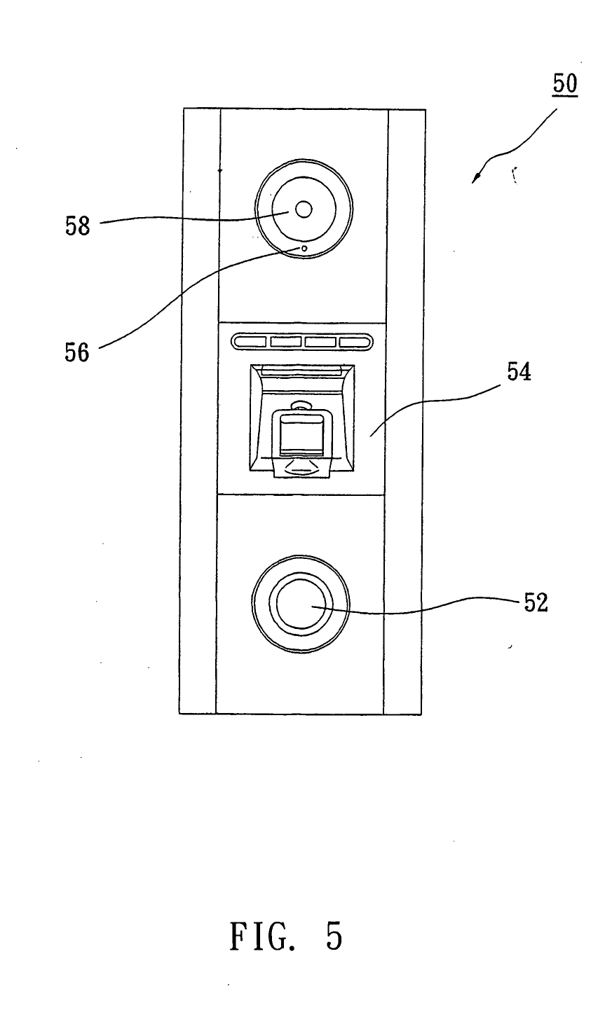

Please refer to as shown in FIG. 5, it is another preferred embodiment of the present invention of fingerprint identifying entrance guard device 50, which structure is the same in the main as the afore-mentioned fingerprint identifying entrance guard device 10. The dissimilarity is that it further contains a doorbell button 52 set up at the bottom of the fingerprint identifier 54 and connected with the buzzer (not shown in the drawing) inside the house provided for the visitors to press and make the buzzer sound. A mini-microphone 56 is set up at the bottom of the monitor 58 and connected to the computer or VCR equipments inside the house so as to record the sound outside the house and to be recorded by the computer or VCR equipments. Hereby, in addition that the Fingerprint Identifying Entrance Guard Device 50 has the afore-mentioned effects, it further has the effect that it can provide the visitor to press the doorbell so as to inform the people inside the house and it can record the sound outside the house.

Accordingly, the present invention of “fingerprint identifying entrance guard device” is a design which integrates the monitor and the fingerprint identifier, not only preserving the security of best burglarproof function of the conventional fingerprint lock, but also creating the effects monitoring the visitor outside the house which the conventional lock is not able to provide. Of course it also save the trouble which the conventional users have to install the outdoor monitoring video cameras by themselves as well the defects which the users are not able to fully monitor the whole appearance and movement of the visitor outside the house because the installed angels of the monitoring video cameras. The total functions are much better and of higher practical value.

What is claimed is:

1. A fingerprint identifying entrance guard device comprising:
a base is set up on a door board of a house;
a fingerprint identifier is set up on the base and connected with the lock on the door board so as to be provided with set up and identify the fingerprint of the visitor, after the fingerprint of the visitor is identified, the lock can then be opened;
a monitor is set up on the base to monitor the appearance of the visitors outside the house.

2. The fingerprint identifying entrance guard device as defined in claim 1, wherein further contains a doorbell button set up on the base and connected with a buzzer so as to be provided for the visitors to press and make buzzer sound.

3. The fingerprint identifying entrance guard device as defined in claim 1, wherein the base is set up by covering relatively with a pedestal and a panel. The fingerprint identifier and monitor is placed between the pedestal and the panel.

4. The fingerprint identifying entrance guard device as defined in claim 3, wherein the fingerprint identifier and the monitor is fixed in the inner side of the panel.

5. The fingerprint identifying entrance guard device as defined in claim 3, wherein the inner side of the end of the panel is set up several bolts. The end of pedestal is set up several sockets jointed with the bolts.

6. The fingerprint identifying entrance guard device as defined in claim 3, wherein the inner side of another end of the panel is set up with several lock holes. Another end of the pedestal is set up several locking base corresponding to the lock holes.

7. The fingerprint identifying entrance guard device as defined in claim 1, wherein the lock connected with the fingerprint identifier is an anode lock.

8. The fingerprint identifying entrance guard device as defined in claim 1, wherein the monitor is a Charge Coupled Device (CCD) video camera.

9. The fingerprint identifying entrance guard device as defined in claim 1, wherein it further contains a mini-microphone set up at the bottom of the monitor.
